(19) United States
(12) Patent Application Publication
(10) Pub. No.: US 2006/0132293 A1
(43) Pub. Date: Jun. 22, 2006

(54) Child alert

(76) Inventors: Robert B. Andersen, Oro Valley, AZ (US); David Patrick Christensen, Oro Valley, AZ (US)

Correspondence Address: ROBERT B. ANDERSEN, 257 CROOKED STICK, ORO VALLEY, AZ, 85737, US

(21) Appl. No.: 10/981,611

(22) Filed: Nov. 5, 2004

(51) Int. Cl. B60Q 1/00

(52) U.S. Cl. 340/425.5

(57) ABSTRACT

The “Child Alert” is a new application of current warning Systems technology to prevent anyone from leaving an infant in a vehicle. It is connected to the vehicle ignition and is activated upon it being turned off. A vocal alert would then sound that a baby is present.

The “Child Alert” utilizes current computer chip technology for motor vehicles and is activated when the ignition is turned to the off position. The “Alert” would verbally warn the operator of the vehicle to not leave a baby in the vehicle.

Our claim is limited to the specific usage of existing technology installed in new or used vehicles equipped with infant safety seats.

1-5. (canceled)

6. A bucket with a handle.

7. A handle comprising an elongated wire.

8. The handle of claim 7 further comprising a plastic grip.

9. A bucket with a blue handle.

10. The bucket of claim 9 wherein the handle is made of wood.

11. (canceled)

12. (canceled)

13. A bucket with plastic sides and bottom.
